(19) United States
(12) Patent Application Publication
(10) Pub. No.: US 2023/0049057 A1
(43) Pub. Date: Feb. 16, 2023

(54) VISUAL REALITY SHOPPING APPLICATION

(71) Applicant: AiFi Corp, Santa Clara, CA (US)

(72) Inventors: Steve Gu, Santa Clara, CA (US); Ying Zheng, Santa Clara, CA (US)

(73) Assignee: AiFi Corp, Santa Clara, CA (US)

(21) Appl. No.: 17/402,616

(22) Filed: Aug. 16, 2021

(51) Int. Cl. G06Q 30/06; G06Q 30/02; G06Q 10/08; G06T 19/00; G06F 3/01

(52) U.S. Cl. CPC G06Q 30/0643; G06F 3/011; G06Q 10/083; G06Q 30/0201; G06Q 30/0222; G06Q 30/0224; G06Q 30/0235; G06Q 30/0623; G06Q 30/0633; G06T 19/006

(57) ABSTRACT

This application relates to systems, methods, devices, and other techniques for utilizing visual reality shopping experience for users.

### BACKGROUND OF THE INVENTION

This application relates to systems, methods, devices, and other techniques that can be utilized for visual reality shopping experience for users.

Methods and apparatus to generate models for testing and training neural networks in a retail store to monitor products and customers are in practice. Visual reality shopping experience for users within a retail environment is new. Furthermore, these techniques and methods can be combined with recently developed AI and machine learning and make the purchase process more accurate and efficient.

Therefore, it is desirable to have new systems, methods, devices, and other techniques to generate visual reality shopping experience for users.

### SUMMARY OF THE INVENTION

In some embodiments, the invention is related to a method of facilitating a visual reality shopping experience.

In some embodiments, the method comprises a step of presenting, by a visual reality application from a set of cameras, a 3-D real-time video feed of a retail store to a display of a device attached to a user, wherein the real-time video feed of the retail store comprises real-time video feed of shelves and retail products on the shelves, wherein the device comprises a visual reality goggle.

In some embodiments, the method comprises a step of configurating, by the visual reality application, a set of triggering features in the 3-D real-time video feed, wherein the set triggering features includes name, price and depictions of products on the shelves.

In some embodiments, the method comprises a step of presenting, by the visual reality application on the display of the device, an image and a three-dimensional multimedia demonstration overlaid on the image and relating to the retail product based on the determination of the retail product.

In some embodiments, the method comprises a step of receiving, by the augmented reality application, a touch input on the retail product in the visual reality application by the user during the presentation of the multimedia demonstration.

In some embodiments, the method comprises a step of presenting information about the retail product based on the touch input.

In some embodiments, the method comprises a step of presenting, by the augmented reality application, a promotion associated with the retail product based on multiple factors, wherein the multiple factors comprise the user’s buying history, special promotion based on expiration date, and special seasonal discount.

In some embodiments, the method comprises a step of recording and processing purchase of the retail product if another touch input by the user to confirm the purchase of the retail product.

In some embodiments, the method comprises a step of shipping the retail product to an address provided by the user.

In some embodiments, the invention is related to a method of facilitating a visual reality shopping experience.

In some embodiments, the method comprises a step of presenting, by a visual reality application from a set of cameras, a 3-D real-time video feed of a retail store to a display of a device attached to a user, wherein the real-time video feed of the retail store comprises real-time video feed of shelves and retail products on the shelves, wherein the device comprises a visual reality goggle.

In some embodiments, the method comprises a step of configurating, by the visual reality application, a set of triggering features in the 3-D real-time video feed, wherein the set triggering features includes name, price and depictions of products on the shelves;

In some embodiments, the method comprises a step of presenting, by the visual reality application on the display of the device, an image and a three-dimensional multimedia demonstration overlaid on the image and relating to the retail product based on the determination of the retail product.

In some embodiments, the method comprises a step of receiving, by the augmented reality application, a touch input on the retail product in the visual reality application by the user during the presentation of the multimedia demonstration.

In some embodiments, the method comprises a step of presenting information about the retail product based on the touch input.

In some embodiments, the method comprises a step of presenting, by the augmented reality application, a promotion associated with the retail product based on multiple factors, wherein the multiple factors comprise the user’s buying history, special promotion based on expiration date, and special seasonal discount.

In some embodiments, the method comprises a step of recording and processing purchase of the retail product if another touch input by the user to confirm the purchase of the retail product.

In some embodiments, the method comprises a step of tracking and analyzing the info of the visual trip in the visual reality application.

In some embodiments, the method comprises a step of sending promotional information to the user based on the analyzing of the info of the visual trip and predictions of items that the user would most likely purchase again.

These and other aspects, their implementations and other features are described in detail in the drawings, the description and the claims.

### BRIEF DESCRIPTION OF THE DRAWINGS

FIG. 1 shows an example of a method of facilitating a visual reality shopping experience.

FIG. 2 shows another example of a method of facilitating a visual reality shopping experience.

### DETAILED DESCRIPTION OF THE INVENTION

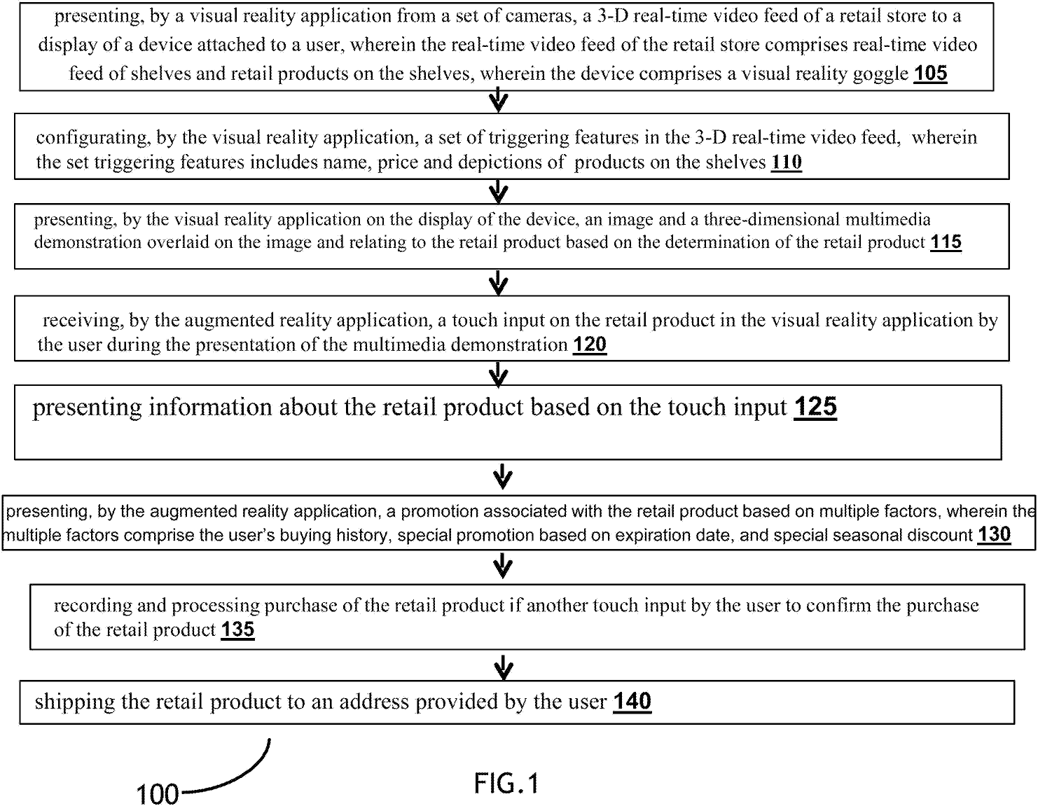

FIG. 1 shows an example of a method 100 of facilitating a visual reality shopping experience.

In some embodiments, the method comprises a step 105 of presenting, by a visual reality application from a set of cameras, a 3-D real-time video feed of a retail store to a display of a device attached to a user, wherein the real-time video feed of the retail store comprises real-time video feed of shelves and retail products on the shelves, wherein the device comprises a visual reality goggle.

In some embodiments, the method comprises a step 110 of configurating, by the visual reality application, a set of triggering features in the 3-D real-time video feed, wherein the set triggering features includes name, price and depictions of products on the shelves.

In some embodiments, the method comprises a step 115 of presenting, by the visual reality application on the display of the device, an image and a three-dimensional multimedia demonstration overlaid on the image and relating to the retail product based on the determination of the retail product.

In some embodiments, the method comprises a step 120 of receiving, by the augmented reality application, a touch input on the retail product in the visual reality application by the user during the presentation of the multimedia demonstration.

In some embodiments, the method comprises a step 125 of presenting information about the retail product based on the touch input.

In some embodiments, the method comprises a step 130 of presenting, by the augmented reality application, a promotion associated with the retail product based on multiple factors, wherein the multiple factors comprise the user’s buying history, special promotion based on expiration date, and special seasonal discount.

In some embodiments, the method comprises a step 135 of recording and processing purchase of the retail product if another touch input by the user to confirm the purchase of the retail product.

In some embodiments, the method comprises a step 140 of shipping the retail product to an address provided by the user.

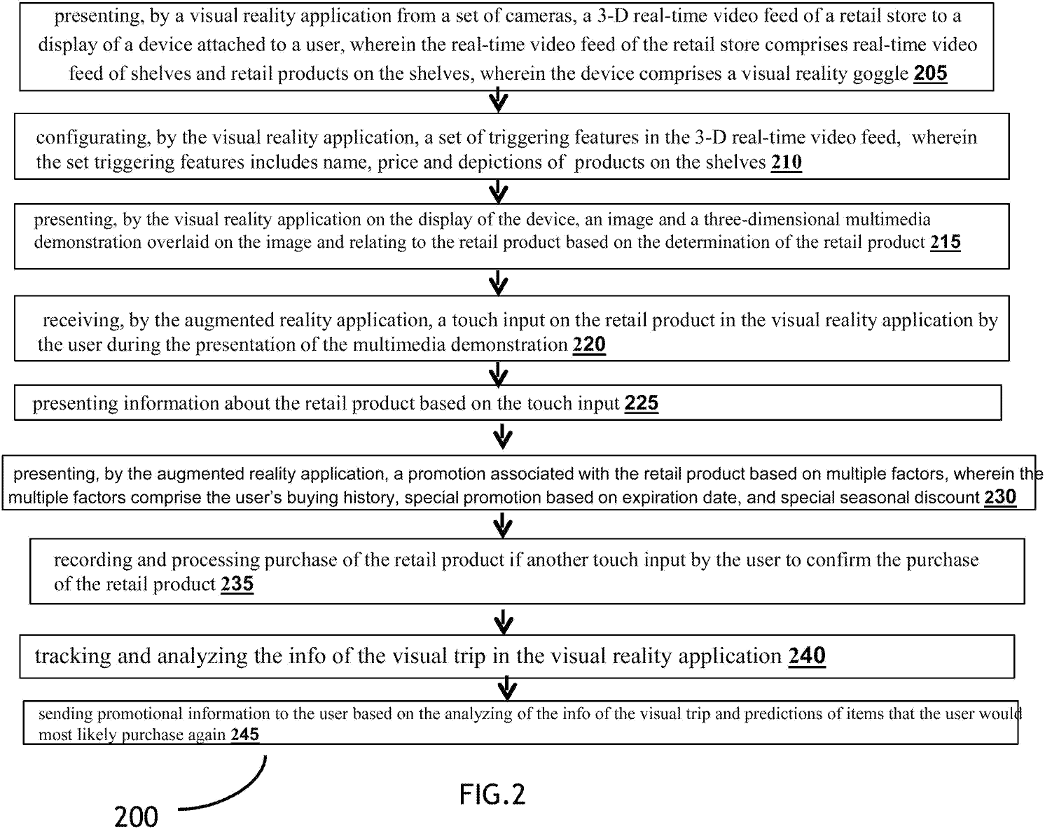

FIG. 2 shows another example of a method 200 of facilitating a visual reality shopping experience.

In some embodiments, the method comprises a step 205 of presenting, by a visual reality application from a set of cameras, a 3-D real-time video feed of a retail store to a display of a device attached to a user, wherein the real-time video feed of the retail store comprises real-time video feed of shelves and retail products on the shelves, wherein the device comprises a visual reality goggle.

In some embodiments, the method comprises a step 210 of configurating, by the visual reality application, a set of triggering features in the 3-D real-time video feed, wherein the set triggering features includes name, price and depictions of products on the shelves.

In some embodiments, the method comprises a step 215 of presenting, by the visual reality application on the display of the device, an image and a three-dimensional multimedia demonstration overlaid on the image and relating to the retail product based on the determination of the retail product.

In some embodiments, the method comprises a step 220 of receiving, by the augmented reality application, a touch input on the retail product in the visual reality application by the user during the presentation of the multimedia demonstration.

In some embodiments, the method comprises a step 225 of presenting information about the retail product based on the touch input.

In some embodiments, the method comprises a step 230 of presenting, by the augmented reality application, a promotion associated with the retail product based on multiple factors, wherein the multiple factors comprise the user’s buying history, special promotion based on expiration date, and special seasonal discount.

In some embodiments, the method comprises a step 235 of recording and processing purchase of the retail product if another touch input by the user to confirm the purchase of the retail product.

In some embodiments, the method comprises a step 240 of tracking and analyzing the info of the visual trip in the visual reality application.

In some embodiments, the method comprises a step 245 of sending promotional information to the user based on the analyzing of the info of the visual trip and predictions of items that the user would most likely purchase again.

1. A method of facilitating a visual reality shopping experience, comprising:
presenting, by a visual reality application from a set of cameras, a 3-D real-time video feed of a retail store to a display of a device attached to a user, wherein the real-time video feed of the retail store comprises real-time video feed of shelves and retail products on the shelves, wherein the device comprises a visual reality goggle;
configurating, by the visual reality application, a set of triggering features in the 3-D real-time video feed, wherein the set triggering features includes name, price and depictions of products on the shelves;
presenting, by the visual reality application on the display of the device, an image and a three-dimensional multimedia demonstration overlaid on the image and relating to the retail product based on the determination of the retail product;
receiving, by the augmented reality application, a touch input on the retail product in the visual reality application by the user during the presentation of the multimedia demonstration;
presenting information about the retail product based on the touch input;
presenting, by the augmented reality application, a promotion associated with the retail product based on multiple factors, wherein the multiple factors comprise the user’s buying history, special promotion based on expiration date, and special seasonal discount; and
recording and processing purchase of the retail product if another touch input by the user to confirm the purchase of the retail product.

2. The method of facilitating a visual reality shopping experience of claim 1, further comprising:
shipping the retail product to an address provided by the user.

3. A method of facilitating a visual reality shopping experience, comprising:
presenting, by a visual reality application from a set of cameras, a 3-D real-time video feed of a retail store to a display of a device attached to a user, wherein the real-time video feed of the retail store comprises real-time video feed of shelves and retail products on the shelves, wherein the device comprises a visual reality goggle;
configurating, by the visual reality application, a set of triggering features in the 3-D real-time video feed, wherein the set triggering features includes name, price and depictions of products on the shelves;
presenting, by the visual reality application on the display of the device, an image and a three-dimensional multimedia demonstration overlaid on the image and relating to the retail product based on the determination of the retail product;
receiving, by the augmented reality application, a touch input on the retail product in the visual reality application by the user during the presentation of the multimedia demonstration;
presenting information about the retail product based on the touch input;
presenting, by the augmented reality application, a promotion associated with the retail product based on multiple factors, wherein the multiple factors comprise the user’s buying history, special promotion based on expiration date, and special seasonal discount; and
recording and processing purchase of the retail product if another touch input by the user to confirm the purchase of the retail product;
tracking and analyzing the info of the visual trip in the visual reality application; and
sending promotional information to the user based on the analyzing of the info of the visual trip and predictions of items that the user would most likely purchase again.
